(19) United States
(12) Patent Application Publication
(10) Pub. No.: US 2003/0090028 A1
(43) Pub. Date: May 15, 2003

(54) Method for producing a membrane module

(76) Inventors: Dieter Bläse, (US); Hans-Peter Feuerpeil, Schw?auml;bisch Gm?uuml;nd (DE); Hans Olapinski, Aichwald (DE)

Correspondence Address: John F Hoffman, Baker & Daniels, Suite 800, 111 East Wayne Street, Fort Wayne, IN, 46802, US

(21) Appl. No.: 10/203,190

(22) PCT Filed: Nov. 16, 2001
(86) PCT No.: PCT/EP01/13273

(30) Foreign Application Priority Data
Dec. 7, 2000 (DE) 100 61 126.5

(51) Int. Cl. B29C 47/00

(52) U.S. Cl. 264/177.11

(57) ABSTRACT

The invention relates to a method for producing a membrane module by means of a forming tool comprising an inlet channel for ceramic material in addition to a plurality of forming cores arranged in the longitudinal direction on the inlet channel. The cross-section of said forming cores is a polygon, preferably a hexagon. The inventive method comprises the following steps: ceramic material is pressed through the inlet channel of the forming tool, resulting in a membrane module blank with a plurality of non-circular preferably hexagonal channels; after production of the membrane module blank, the interior of the plurality of the channels is coated by applying membrane slip, resulting in an inner channel with an approximately circular geometry.

The invention concerns a method for producing a membrane module as well as a membrane module produced based on this method.

Membrane modules with a multitude of channels for use in membrane filtration, for example, in microfiltration, ultrafiltration, and nanofiltration, have become well known from a wealth of publications.

In this regard, we refer to DE 198 46 041 or EP 0 270 051, the disclosure capacity of which is also taken up extensively in this notification. These types of membrane modules include a multitude of channels that are arranged parallel to each other. The surfaces of the individual channels of the membrane module are coated with a membrane made of a ceramic material that serves as a filter layer. These types of modules serve, in particular, to separate a component from a liquid or a gas. Hereby, the liquid or the gas is passed through a multitude of channels of the membrane module. The ceramic between the individual channels forms the filter medium. The substances to be separated are held back on the ceramic membrane. The substance(s) passing through the membrane, which is also characterized as the filtrate, is free of the components to be separated. The liquid enriched with the pollutants remains in the channels, the so-called residue, which is removed.

In the state of the art, extrusion forming tools with an inlet channel and forming cores arranged in the longitudinal direction on the inlet channel, which are fixed in the inlet channel via a point suspension and a holding structure, are used in the production of ceramic membrane modules. The forming cores have, for example, a circular cross-section, corresponding to the cross-section of the individual channels of the ceramic membrane module. The circular channel cross-section is particularly preferred in cross-flow filtration, since the even overflow current on the membrane surface leads to better filtration results.

Particularly with ceramic membrane modules with a multitude of channels, the round hole geometry led to an unfavorable proportion of the free surface at the entrance of the extrusion tool to the free surface at its exit, which is also described as compression.

Forming tools with forming cores, the cross-sections of which are polygons or hexagons, are also known. With hexagonal channels, the ratio from the free surface at the entrance to the free surface at the exit can be improved, but the problem arises that deposits form during the use of such membrane modules in filtration/cross-flow filtration due to the lack of turbulence in the corners of the channels with hexagonal cross-sections. The purpose of the invention is to provide a method for producing a membrane module that can overcome the drawbacks of the state of the art; in which the wall thickness between the individual forming cores is constant, a favorable ratio of the free surface at the entrance to the free surface at the exit is attained, and deposits in the membrane channels during filtration are avoided.

In accordance with the invention, this purpose is fulfilled in that, with the help of a forming tool, a ceramic membrane blank with non-circular channels is created; in a second procedural step, the inner channels are coated with a suitable membrane slip, resulting in a round inner channel. In particular, this is the case when, e.g., the diameter of the hexagonal channels is clearly smaller than 6 mm.

In particular, positive results are attained with hexagonal inner channels with a diameter under 3 mm or, even better, under 2 mm.

The invention is to be described exemplarily based on the figures.

The following is shown:

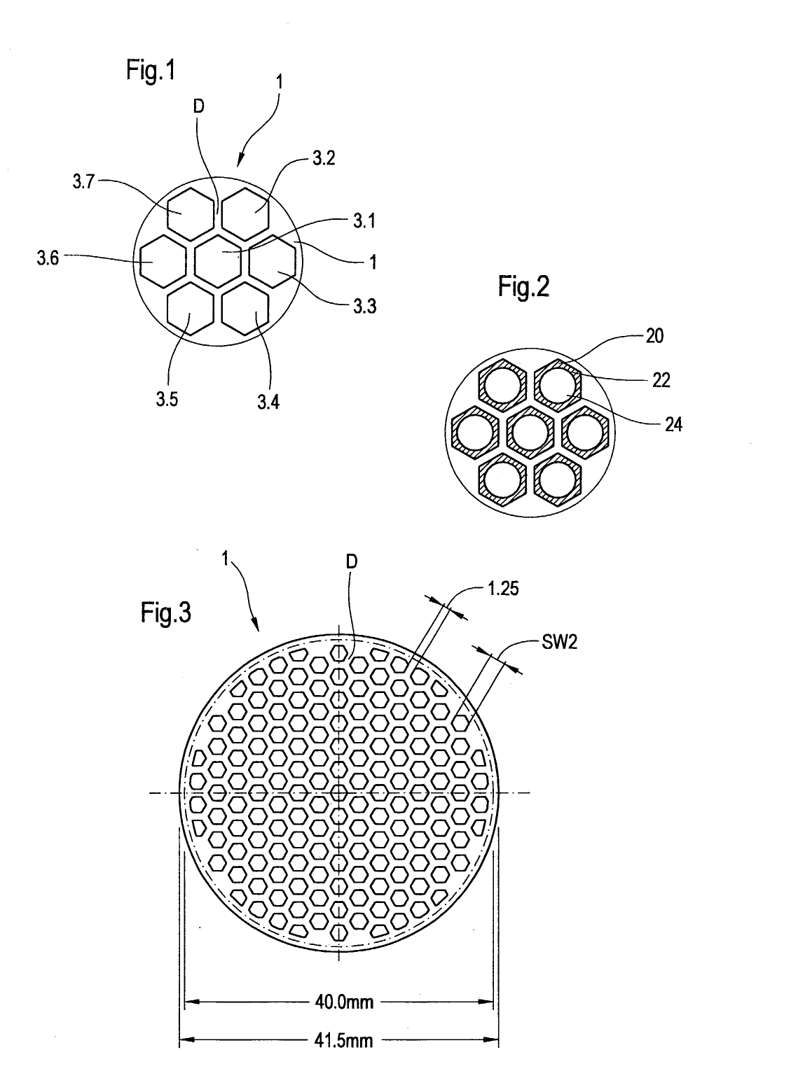

FIG. 1: Top view of a ceramic membrane module blank, produced with a forming tool comprising several channels with a hexagonal cross-section.

FIG. 2: Top view of a ceramic membrane module, whereby the hexagonal inner channels are also coated.

FIG. 3: A ceramic membrane module blank with a multitude of hexagonal channels.

FIG. 1 shows a diagram of the top view of a ceramic membrane module blank 1, in which the individual channels 3.1, 3.2, 3.3, 3.4, 3.5, 3.6, and 3.7 have a hexagonal cross-section. Other polygon cross-sections are also conceivable. The ceramic membrane module blank 1 is distinguished by the constant distance D of the individual side surfaces of neighboring hexagons from each other. The distance D of the individual cores equals, for example, 0.5 to 1.5 mm, giving the wall thicknesses between the channels of the resulting ceramic module.

The ceramic membrane module blank is obtained by pressing a ceramic material into a forming tool through the inlet channel of the non-represented forming tool. In the following example, the forming tool comprises seven channels with a hexagonal cross-section. The cross-section of the ceramic membrane module blank corresponds to the cross-section of the forming core of the forming tool. The disadvantage of a ceramic membrane module with non-circular inner channels would be that deposits could precipitate in the corners of the channels with non-circular cross-sections.

In order to avoid this, the invention provides that the inner channels 20 of the ceramic membrane module with a hexagonal cross-section, as shown in FIG. 2, are to be charged with a membrane slip so that a channel 24 with an almost circular cross-section is formed.

The advantage of the invented procedure and the invented forming tool affects, in particular, the production of ceramic modules with more than 91 channels.

FIG. 3 shows a ceramic module blank with a multitude of channels with a hexagon cross-section, which, through charging with a ceramic material, result in channels with a circular cross-section. The distance of the side surfaces between the individual hexagonal channels equals 1.25 mm, the diameter of the individual channels, 1.6 mm. The outer diameter of the ceramic module blank equals 41.5 mm in this example.

With the invention, a procedure for producing ceramic membrane modules is given for the first time and is distinguished by a large number of almost round inner channels and a sufficiently high compression during the production of the ceramic module.

1. Method for producing a membrane module with a forming tool with an inlet channel for ceramic material as well as a multitude of forming cores arranged in the longitudinal direction on the inlet channel and the cross-section of the forming cores is a polygon, preferably a hexagon, comprising the following steps:
1.1 Ceramic material is pressed through the inlet channel of the forming tool, resulting in a membrane module blank with a multitude of channels with a noncircular, preferably hexagonal, cross-section.
1.2 After producing the membrane module blank, the interior of the multitude of channels is coated by the introduction of a membrane slip, resulting in inner channels with an almost circular geometry.

2. Ceramic membrane module with a multitude of channels, characterized in that the membrane module is produced according to a procedure in accordance with claim 1.

3. Ceramic membrane module in accordance with claims 2, characterized in that the diameter of the inner channels is smaller than 6 mm, preferably smaller than 3 mm, and, most preferably, smaller than 2 mm.

4. Ceramic membrane module in accordance with claim 2 or 3, characterized in that the membrane module has more than 36 channels, preferably more than 60, and, most preferably, more than 90.

5. Use of a membrane module in accordance with one of the claims 2 to 4, in one of the following fields:
micro-, ultra-, and nanofiltration
pervaporation
dead-end filtration
cross-flow filtration with overflow media
filtration of drinking water
